(19) United States
(12) Patent Application Publication
(10) Pub. No.: US 2022/0034357 A1
(43) Pub. Date: Feb. 3, 2022

(54) MONOBLOCK TUBE FOR A DRIVESHAFT

(71) Applicant: TIRSAN KARDAN SANAYI VE TICARET A.S., Manisa (TR)

(72) Inventor: Korkut Tasan, Manisa (TR)

(21) Appl. No.: 17/277,263

(22) PCT Filed: Jun. 22, 2019
(86) PCT No.: PCT/TR2019/050489

§ 371 Date: Mar. 17, 2021

(30) Foreign Application Priority Data
Sep. 21, 2018 (TR) 2018/13606

(51) Int. Cl. F16C 3/02

(52) U.S. Cl. CPC F16C 3/02; F16C 2326/06; F16C 2220/42

(57) ABSTRACT

The invention relates to a tube assembly for a driveshaft comprising an elongated first tube portion (14) having a first diameter (d1) and a monoblock tube (10) comprising a coaxially elongated second tube portion (15) having a second diameter (d2) narrow than the first diameter (d1) forming a shaft by shrinking the first tube portion (14) in an elbow section (16) provided therebetween.

### TECHNICAL FIELD

The present invention relates to components of driveshafts, in particular to spline shaft and tube structures thereof.

### PRIOR ART

In vehicles, transmission means are used to transmit rotational power from the engine or transmission assemblies to rotate one or more wheels. Driveshafts, as a commonly used drivetrain, include a central bearing and a yoke in addition to the universal joint and ensure smooth transfer of driving force between the front and rear parts of the vehicle, despite changes in relative position. Due to the high torque transmitted, the driveshafts are designed to have high torsional stiffness and sufficient bending stiffness.

On the driveshaft, the rear shaft is sliding to compensate for changes in distance in motion. The elements providing the sliding structure consist of a tube and a coaxial shaft connected to the tube by welding operation. There are axially extending channels in the outer periphery of the shaft. In the welding part of this double structure obtained by welding seam, the mechanical strength properties of the part remain weak compared to other parts.

### BRIEF DESCRIPTION

The object of the invention is to increase the structural integrity of the spline assembly in driveshafts.

In order to reach above object, the invention relates to a tube assembly for a driveshaft comprising an elongated first tube portion having a first diameter. The tube assembly is having a monoblock tube comprising a coaxially elongated second tube portion having a second diameter narrow than the first diameter forming a shaft by shrinking the first tube portion in an elbow section provided therebetween. The monoblock structure allows a lighter construction with a longer life against torsional fatigue comparing with other shafts with same dimensions. The monoblock structure consisting of the first and second tube portions can be obtained by forming various cross-sections on the monoblock piece by plastic forming from a single tube element.

In a preferred embodiment, a thin wall is formed by expanding a cylindrical thick wall of the the second tube portion into the first tube portion. The first and the larger diameter thin section and the second and lower diameter thicker section were obtained, thus making it possible to provide a high strength construction without any weakness in torque transfer.

In a preferred embodiment, outer periphery of the second tube portion comprises a plurality of radially spaced channels which are axially formed from one end to the front edge. The channels provide a sliding structure. Additionally, the channels on the second tube section can be obtained by plastic forming methods. Preferably, the shape form of each channel is identical. This ensures an even distribution of internal stresses.

In a preferred embodiment of the invention, the length of the first tube portion is substantially greater than the length of the second tube portion. Thus, a monoblock structure is provided which can be easily adapted to the sliding system in the driveshaft, where the second tube portion forms the shaft.

In a preferred embodiment of the invention, the elbow section between the first tube portion and the second tube portion has an S-like form. This makes it possible to form the first tube portion by expanding it without any cracks or structural damage by forming plastic from a single diameter tube, for example a tube corresponding to the second diameter of the second tube portion.

A preferred embodiment is a driveshaft comprising a tube assembly as described above.

### DESCRIPTION OF THE FIGURES

FIG. 1 is a front view of a two-piece driveshaft comprising the coupling device of the invention.

FIG. 2 is a cross-sectional illustration of a representative embodiment of the monoblock tube according to the invention.

### DETAILED DESCRIPTION

In this detailed description, the development according to the invention is described with no limitation and only with reference to the examples to better illustrate the subject matter.

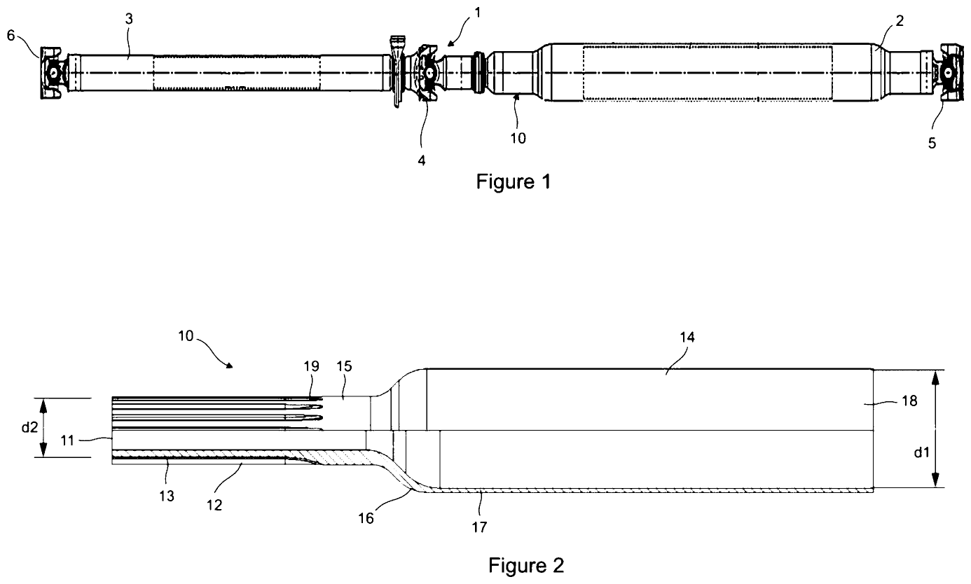

FIG. 1 is a frontal view of a two-piece driveshaft (1) comprising a representative embodiment of the monoblock tube of the invention. A rear joint (5) is mounted at the rear of the rear shaft (2). In the front part of the rear shaft (2), there is a representative embodiment of the monoblock tube (10) according to the invention. The monoblock tube (10) passes axially to the coaxial sliding yoke (4). The yoke (4) is connected to the front shaft (3) by the cross-link, which transmits torque. The front shaft (3) is rigid and has a front joint (6) mounted at a front end.

In FIG. 2, the monoblock tube (10) is shown in cross section. A first tube portion (14) is a first diameter (d1) having a tube diameter that is standard for the driveshaft (1). The first tube portion (14) has a planar terminating rear edge (18). The first tube portion (14) is of a hollow cylindrical structure with a thin wall, i.e. a thin wall (17). The front portion of the first tube portion (14) reaches a second diameter (d2) by narrowing the diameter with an S-like elbow section (16). The coaxial hollow second tubular portion (15) extends integrally from the portion narrowed by the elbow section portion (16). The second tube portion (15) is of standard shaft diameter for the driveshaft (1) and comprises a thick wall (13) which is thicker than the thin wall (17). On the second tube portion (15), axial channels (12) extend from the front edge (11) to the rear. The channels (129 are of uniform form and encircle the second tube portion (15) at equal spacing from one another. The end of the channels (12), which is close to the first tube portion (14), has a bottom end (19) whose depth decreases radially outwardly.

REFERENCE NUMBERS

| | |
|---|---|
| 1 | Driveshaft |
| 2 | Rear Shaft |
| 3 | Front Shaft |
| 4 | Yoke |
| 5 | Rear Joint |
| 6 | Front Joint |
| d1 | First Diameter |
| d2 | Second Diameter |
| 10 | Monoblock Tube |
| 11 | Front Edge |
| 12 | Channel |
| 13 | Thick Wall |
| 14 | First Tube Portion |
| 15 | Second Tube Portion |
| 16 | Elbow section |
| 17 | Thin wall |
| 18 | Rear Edge |
| 19 | Bottom end |

1. A tube assembly for a driveshaft comprising an elongated first tube portion having a first diameter characterized in that a monoblock tube comprising a coaxially elongated second tube portion having a second diameter narrow than the first diameter forming a shaft by shrinking the first tube portion in an elbow section provided therebetween.

2. The tube assembly according to claim 1, wherein a thin wall is formed by expanding a cylindrical thick wall of the the second tube portion into the first tube portion.

3. The tube assembly according to claim 1, wherein outer periphery of the second tube portion comprises a plurality of radially spaced channels which are axially formed from one end to the front edge.

4. The tube assembly according to claim 3, wherein each one of the channels are formed identical to each other.

5. The tube assembly according to claim 1, wherein the length of the first tube portion is substantially greater than the length of the second tube portion.

6. The tube assembly according to claim 1, wherein the elbow section between the first tube portion and the second tube portion has an S-like form.

7. A driveshaft comprising a tube assembly according to claim 1.
